(19) United States
(12) Patent Application Publication
(10) Pub. No.: US 2022/0395997 A1
(43) Pub. Date: Dec. 15, 2022

(54) METHOD FOR PRODUCING A PUZZLE AND SEPARATING DEVICE FOR THE SAME

(71) Applicant: puzzle & play GmbH, Altenstadt a.d. Waldnaab (DE)

(72) Inventor: Norbert WEIG, Parkstein (DE)

(21) Appl. No.: 17/346,584

(22) Filed: Jun. 14, 2021

(51) Int. Cl. B26D 7/18; A63F 9/10; B26F 1/38; B65B 35/50; B65B 5/08

(52) U.S. Cl. CPC B26D 7/18; A63F 9/1044; B26F 1/38; B65B 35/50; B65B 5/08; A63F 2009/1072; B26D 7/1818; B26D 7/1836

(57) ABSTRACT

A method for producing a puzzle including a plurality of puzzle pieces which, in an assembled state, form the puzzle, wherein, in the method, an image is laminated or printed onto a carrier plate so that the image defines an image plane on the carrier plate, and the puzzle pieces are punched out of the printed or laminated carrier plate or wherein the carrier plate is punched and an image is printed onto the punched carrier plate so that the image defines an image plane on the carrier plate, wherein the puzzle pieces are detached and separated from the punched carrier plate in a predetermined way by a controlled movement of at least one puzzle piece transverse to the image plane. A corresponding device is also disclosed.

### BACKGROUND OF THE INVENTION

### Field of the Invention

The invention relates to a method for producing a puzzle including a plurality of puzzle pieces which, in an assembled state, form an image, as well as a separating device for separating the puzzle pieces during the manufacturing process.

### Prior Art

Puzzles are known products in which a motif such as, for example, a photo, a drawing, or designed graphics is processed into a puzzle. The motif is frequently selected by the manufacturer of the puzzle to then produce a plurality of puzzles having identical motifs. In the meantime, it is also possible that the customer uses a personal motif and uploads it as part of his/her order, for example via a website or an app.

The production of such a puzzle is typically carried out by printing or laminating an image onto a carrier material or carrier plate such as, for example, cardboard, wood, plastic, foamed material and the like and subsequently punching the carrier plate to produce the individual puzzle pieces of the puzzle. After punching, the puzzle pieces have to be separated Since the puzzle pieces are kept together by the positive connections by means of which they are subsequently reassembled by the user. In addition, it may occur that no complete separation of the puzzle pieces from each other is achieved by punching and that they are still materially connected to each other by thin portions.

According to prior art, the separation of the puzzle pieces is either carried out manually or by machine, the puzzle to be separated being placed on, for example, a conveyer belt and the individual puzzle pieces breaking off or being broken up by rotating rods at the end of the conveyer belt. In this way, a chaotic, loose heap of puzzle pieces is produced, it no longer being discernible here whether actually all puzzle pieces found their way from the separation into a storage container in which the puzzle is sold to the user. Accordingly, there is frequently the problem that individual puzzle pieces are missing and that the puzzle can therefore no longer be completely assembled.

In addition, there is the problem in the known method and devices for separating puzzle pieces that a lot of dust is produced which is difficult to suck off and that there is the risk that puzzle pieces which are not completely separated are damaged while being indiscriminately broken up so that the image present on the puzzle is damaged and the puzzle pieces become useless.

### DISCLOSURE OF THE INVENTION

### Object of the Invention

It is the object of the present invention to provide a method and a device which render a better separation of puzzles possible to solve the abovementioned problems of prior art and, in particular, render a targeted and defined separation of the puzzle pieces possible so that the puzzle pieces can be further processed in a controlled and aimed manner.

### Technical Solution

This object is solved by a method having the features of claim 1 as well as a device having the features of claim 11. Advantageous embodiments are the subject matter of the dependent claims.

For solving the object, the invention proposes a method for producing a puzzle including a plurality of puzzle pieces which, in an assembled state, form the puzzle, wherein, in the method, an image is laminated or printed onto a carrier plate so that the image defines an image plane on the carrier plate, and the puzzle pieces are punched out of the printed or laminated carrier plate. Alternatively, the order may also be reversed so that first a carrier plate laminated or otherwise suitable for printing is punched and the image is then printed onto the punched carrier plate. Here, an image is understood to be any representation suitable for a puzzle, and, as a carrier material for the carrier plate, a wide variety of materials such as cardboard, plastic, wood, and the like is eligible. The same applies to printing or laminating. In addition, punching is understood to describe any type of separation of the puzzle pieces and not only the specific process of punching. In particular, a separation may also be carried out by sawing, cutting, laser cutting, or the like. According to the invention, the puzzle pieces are detached and separated from the punched carrier plate in a predetermined way by a controlled movement of at least one puzzle piece transverse to the image plane so that the puzzle pieces are arranged in a defined manner after separation.

The controlled movement may, in particular, be performed perpendicular to the puzzle plane defined by a main surface having the largest dimensions of the puzzle or the carrier plate or perpendicular to the image plane.

One or a plurality of puzzle pieces may be simultaneously and/or successively detached from the punched carrier plate to ensure, on the one hand, an efficient separation in the shortest possible time and, on the other hand, nevertheless a defined separation. Specifically, up to half of the puzzle pieces of the puzzle may be simultaneously detached from the punched carrier plate, or all puzzle pieces may be simultaneously separated.

For the puzzle to be separated, a plurality of sub-segments may be defined, each sub-segment comprising specific puzzle pieces, and at least one puzzle piece may be simultaneously detached from the punched carrier plate in all sub-segments, respectively. Alternatively, all puzzle pieces of one or more sub-segments may be simultaneously detached from the punched carrier plate, wherein, particularly in case of a detached sub-segment, a further separation of the puzzle pieces of the sub-segment may be performed according to the present method or another method.

The puzzle pieces of a sub-segment may also be defined by at least one characteristic of the puzzle pieces selected from a number of characteristics including the association with one or more rows of the puzzle, the association with part of one or more rows of the puzzle, the association with one or more columns of the puzzle, the association with part of one or more columns of the puzzle, the association with an arbitrary local area of the puzzle, one or more primary colours or colour components of the puzzle pieces, edge pieces of the puzzle, the number of recesses or projections of the puzzle pieces and combinations thereof.

In order to avoid displacement or tilting of one or more adjacent puzzle pieces during the process of detaching one or more puzzle pieces one or more adjacent puzzle pieces or all puzzle pieces adjacent to the puzzle piece to be detached or all puzzle pieces adjacent to the puzzle piece to be detached which have a common section line may be fixed during the movement of the puzzle piece to be detached.

The controlled movement for detaching the at least one puzzle piece may be a linear translational movement, particularly a pushing or pulling movement.

The detachment of the puzzle pieces may, in particular, be performed so that the detached puzzle pieces are disposed in a common plane which is, in particular, parallelly offset relative to the image plane of the unmoved puzzle pieces after the detachment from the punched carrier plate. In this way, a simple and defined access to the separated puzzle pieces is possible after separation for convenient further processing.

Following the controlled movement for detaching the at least one puzzle piece, the at least one puzzle piece may be placed or stacked in a storage container. In particular, the puzzle pieces of a sub-segment may be placed in a common storage container in case of a segment-wise separation of the puzzle pieces.

According to a further aspect of the invention for which protection is sought independent of and in combination with the method, a device for separating puzzle pieces of a puzzle including a plurality of puzzle pieces is proposed. The device comprises an accommodation element for the puzzle of puzzle pieces connected to each other and at least one moving element, the at least one moving element being movable relative to the accommodation element so that at least one contact element comes into contact with at least one puzzle piece and the puzzle piece is moved transverse to the accommodation element by the contact element so that the at least one puzzle piece is detached from the puzzle. Here, the accommodation element defines a support surface parallel to the image plane of the puzzle or the puzzle plane so that the movement for detaching the puzzle element is transverse and particularly perpendicular to the image plane of the puzzle.

According to one embodiment, the moving element may be a plate having a plurality of projections and cavities on one side or a main surface of the plate having the largest dimensions. In particular, the number of the projections and cavities maybe up to half of the number of the puzzle pieces to be separated, respectively. In this embodiment, the projections are the contact elements. The accommodation element is also formed as a plate with projections and cavities complementary to the moving element, the projections being a support for the puzzle to be separated so that, when the puzzle to be separated is disposed on the accommodation element and the moving element is moved in the direction of the accommodation element, one or more puzzle pieces are pushed into the complementary cavity of the accommodation element by each projection of the moving element. In this way, in particular, all puzzle pieces of a puzzle can, be separated from each other with a single movement for separation.

Each cavity or each projection of the accommodation element or of the moving element may correspond to at least one puzzle piece and/or one sub-segment of a plurality of puzzle pieces of the puzzle to be separated.

According to another embodiment, the moving element may be a movable pushing and/or pulling element, particularly a die and/or a suction element.

In this embodiment, the contact element may be formed by a pushing surface of a pushing element, particularly the die surface of a die, or the coupling surface of a pulling element, particularly the suction nozzle of a suction element.

The device may comprise a plurality of moving and contact elements which are simultaneously movable so that a plurality of puzzle pieces can be simultaneously detached from the puzzle to be separated. In particular, the moving and contact elements may be arranged in a moving element support so that one or more moving and contact elements which are simultaneously movable are disposed in a portion of the moving element support, respectively, each portion potentially corresponding to a sub-segment of the puzzle to be separated so that the puzzle pieces can be detached individually and successively within a sub-segment of the puzzle.

However, the device may include a moving and contact element for each puzzle piece or each sub-segment of the puzzle to be separated, respectively.

The contact elements may be formed and/or arranged in a moving element support so that the contact elements almost completely cover the surface of the puzzle to be separated. Here, the contact elements may, at least in part, laterally abut against each other. For avoiding jams or wear, the contact elements may be elastically deformable at their peripheral portion.

Since the puzzle to be separated may include puzzle pieces of a wide variety of designs and the arrangement of the puzzle pieces in the punched carrier plate may change due to wear the moving and/or contact elements may be arranged in a moving element support so that the moving and/or contact elements are slidable transverse to the direction of the movement during the detachment of a puzzle piece from the puzzle to be separated in at least one, preferably in two directions extending transverse to each other within the moving element support so as to render adjustments possible.

The contact elements may have differing contact surfaces adapted to the size of the allocated puzzle piece or sub-segment or the allocated puzzle pieces or sub-segments of the puzzle to be separated.

The device may further include fixation means serving to fix the puzzle pieces disposed adjacent to a puzzle piece to be detached which are not to be detached. The fixation means may, in particular, include a clamping ring or frame by means of which the puzzle piece or the puzzle pieces to be fixed can be clamped against the accommodation element.

At least one moving and/or contact element may be formed in the device so that it has a fixing position in which it can fix one or more puzzle pieces laterally and/or in the direction of the movement during the detachment.

The accommodation element may include a support plate for supporting a puzzle to be separated, the support plate, being capable of providing for a support surface. Furthermore, the support plate may have at least one, preferably a plurality of holes through which the at least one moving and/or contact element or a detached puzzle piece can be moved, wherein, in particular, a moving and/or contact element may be allocated to each hole.

In particular, the at least one moving and/or contact element may be movable transverse to the direction of the movement during the detachment of a puzzle piece from the puzzle to be separated relative to the puzzle to be separated in at least one, preferably in two directions extending transverse to each other together with a moving element support in which it is supported to move the various puzzle pieces to the respective moving and/or contact element. In the same way, also, the accommodation element may be movable relative to the puzzle.

Conversely, the device may also comprise puzzle moving means by means of which the puzzle to be separated or parts of a remaining puzzle are movable relative to a moving element support and/or to the accommodation element, particularly slidable on the accommodation element.

The device may further include puzzle part take-up means for taking up an individual or a plurality of detached puzzle pieces. The puzzle part take-up means may include a gripping or suction device for at least one puzzle piece or preferably all puzzle pieces. In addition, a receiving container, particularly a cylindrical receiving container having a diameter adapted to the puzzle pieces or a receiving container having grid or perforated walls may be provided. The dimensions or the diameter of the receiving container may be adapted to the puzzle pieces so that the puzzle pieces cannot twist or tilt in the receiving container so that a stack can be formed in the receiving container. The dimensions of the receiving space in the receiving container may, preferably, be adjustable by a movable piston. The grid or perforated walls of the receiving container render sucking off dust generated during the separation of the puzzle pieces possible.

The device may further include operating means for operating the moving element or the moving elements which preferably include one or more operating elements allocated to the moving elements which are, in particular, disposed at fixedly predetermined positions in a direction transverse to the direction of the movement during the detachment of a puzzle piece.

### BRIEF DESCRIPTION OF THE FIGURES

In the accompanying drawings, the following is shown in a purely schematic form.

FIG. 1 shows a portion of a plan view of an accommodation element of a device according to the invention for separating puzzle pieces in the form of a plate having projections and cavities;

FIG. 2 shows a lateral cross-sectional view of a device according to the invention including a moving element and an accommodation element in the form of plates having projections and cavities;

FIG. 3 shows a lateral cross-sectional view of part of a device according to FIG. 2 after a separation process;

FIG. 4 shows a lateral cross-sectional view similar to FIG. 2 in which, however, the projections and cavities are dimensioned for separating sub-segments including a plurality of puzzle pieces of the puzzle;

FIG. 5 shows a plan view of the accommodation element of a device according to FIG. 4;

FIG. 6 shows a plan view of the moving element of a device according to FIG. 4;

FIG. 7 shows a lateral cross-sectional view of another embodiment of a device according to the invention for separating puzzle pieces of a puzzle;

FIG. 8 shows an illustration of an arrangement of a perforated plate of a device similar to the device according to FIG. 7 relative to a puzzle to be separated;

FIG. 9 shows a lateral cross-sectional view of part of another embodiment of a device according to the invention for separating puzzle pieces; and

FIG. 10 shows a lateral cross-sectional view of part of yet another embodiment of a device according to the invention for separating puzzle pieces.

### EMBODIMENTS

Further advantages, characteristics and features of the present invention will become apparent from the following detailed description of the embodiments. However, the invention is not limited to these embodiments.

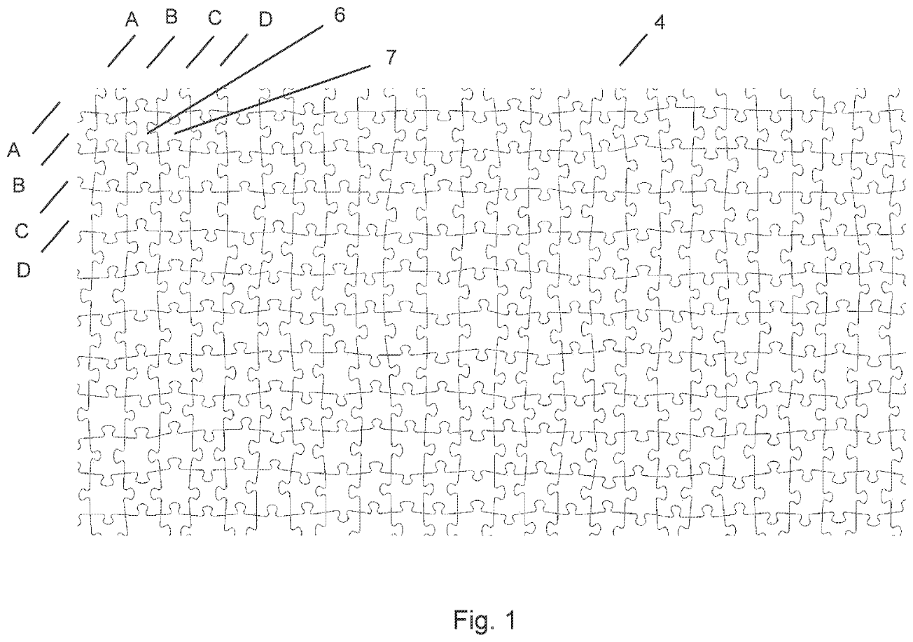

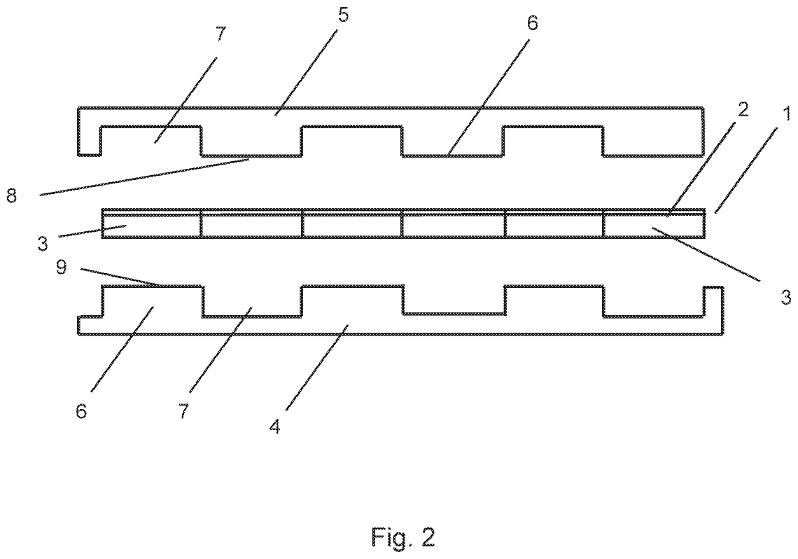

FIG. 1 shows a portion of a plan view of an accommodation element of a device according to the invention for separating puzzle pieces in the form of a plate having projections and cavities, while in FIG. 2, a lateral cross-sectional view of a corresponding device can be seen. In FIG. 2, the puzzle 1 to be separated including a plurality of puzzle pieces 3 can be seen. The puzzle 1 is comprised of a carrier plate onto which an image 2 is laminated or printed. The puzzle 1 in FIG. 2 is already divided into the plurality of puzzle pieces 3 by a cutting or punching process, a connection of the puzzle pieces, however, still existing in directions in the image plane due to the mutual positive connection of the puzzle pieces 3. In addition, it may occur that, in the cutting or punching process, no complete separation is achieved but that a thin material connection by the carrier material continues to exist.

FIG. 2 shows a lateral cross-sectional view of a first embodiment of a device according to the invention for separating puzzle pieces 3 of a puzzle 1. The device shown in FIG. 2 includes an accommodation element 4 in the form of a plate having projections 6 and cavities 7 as well as a moving element 5 likewise having projections 6 and cavities 7 which are complementary to the projections 6 and cavities 7 of the accommodation element 4. The projections of the accommodation element 4 include support surfaces 9 serving to support the puzzle 1 to be separated. The projections 6 of the moving element 5 are contact elements having contact surfaces 8 which come into contact with the puzzle pieces 3 to be detached from the puzzle 1 when the moving element 5 is moved in the direction of the accommodation element 4 to perform a separation process. The contact surfaces 8 of the projections 6 of the moving element 5 push part of the puzzle pieces 3 out of the puzzle 1 into the cavities 7 of the accommodation element 4 with a movement of the moving element 5 in direction of the accommodation element 4 so that the puzzle pieces 3 are separated.

Since, as illustrated in FIG. 1, the projections 6 and cavities 7 are alternately arranged in correspondence with the puzzle pieces 3 of the puzzle 1 to be separated all puzzle pieces 3 of the puzzle 1 to be separated are separated from each other in a single movement of the moving element 5 in direction of the accommodation element 4 and arranged in defined positions.

In FIG. 1, it can be seen in a plan view of the associated accommodation element 4 that, for a puzzle 1 in which the puzzle pieces 3 are arranged in a plurality of rows A, B, C, D . . . and columns A, B, C, D . . . , for example, the puzzle element in row B and column B is formed as a projection 6 while the adjacent puzzle element in row B and column C is formed as a cavity. Accordingly, the puzzle elements in row A, column B, row B, column A and row C, column B are also formed as cavities while, for example, the puzzle element in row C and column C is again formed as a projection. However, so-called random cut puzzles without a row and column structure can of course also be separated correspondingly.

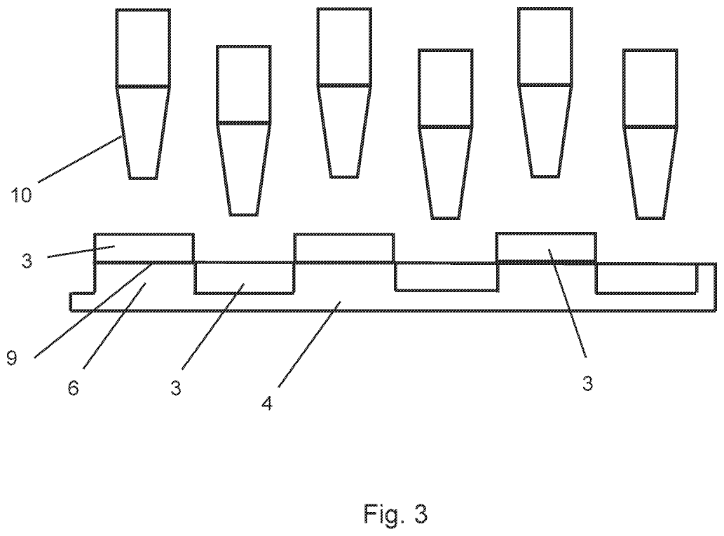

FIG. 3 shows a side view of the situation after a separation process performed by a device according to FIG. 2. As can be seen in FIG. 3, part of the puzzle pieces 3 are located in the cavities 7 of the accommodation element 4 while the remaining puzzle pieces 3 lie on top of the projections 6 or support surfaces 9 so that all puzzle pieces 3 are separated from each other after a single moving process for separating the puzzle pieces 3 and can be further processed in a defined manner.

In FIG. 3, it is schematically shown that puzzle part take-up means may, for example, include a plurality of suction nozzles 10, preferably exactly the number of suction nozzles 10 as the number of separated puzzle pieces 3 so that a plurality of puzzle pieces 3 or preferably all puzzle pieces 3 can be simultaneously taken up by the puzzle part take-up means or the suction nozzles 10 and further processed. For example, the puzzle pieces 3 held by the puzzle part take-up means may be individually and successively placed in a desired location by suitably switching the suction nozzles 10, or a plurality of puzzle pieces 3 may be simultaneously deposited depending on how the suction nozzles 10 are switched.

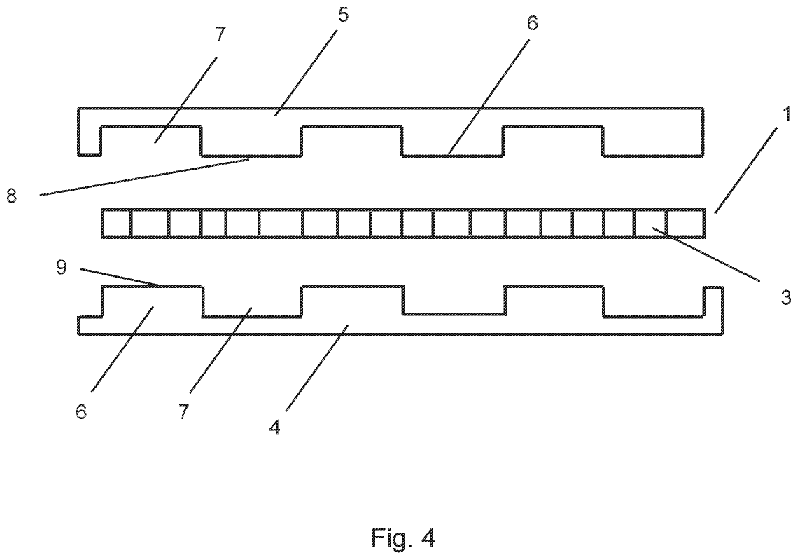

FIG. 4 shows another embodiment of a device according to the invention for separating puzzle pieces 3 which is substantially identical to the device of FIG. 2. However, the dimensions of the lateral extension of the projections 6 and cavities 7, i.e. the dimensions in directions parallel to the image plane of the puzzle 1, are dimensioned differently so that a cavity 7 of the accommodation element 4 can accommodate a plurality of puzzle pieces 3 or a sub-segment of the puzzle 1 to be separated which comprises, for example, a plurality of puzzle pieces 3 adjacent to each other along the rows and columns of a puzzle 1 so that the puzzle 1 to be separated is separated segment-wise. The separated sub-segments of the puzzle 1 have to be further separated correspondingly then if desired, to which end devices according to the invention or prior art devices or methods may be deployed.

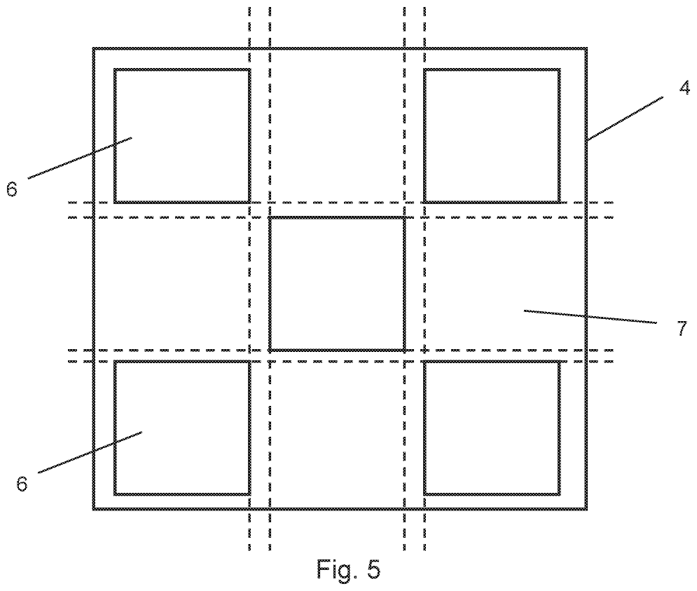

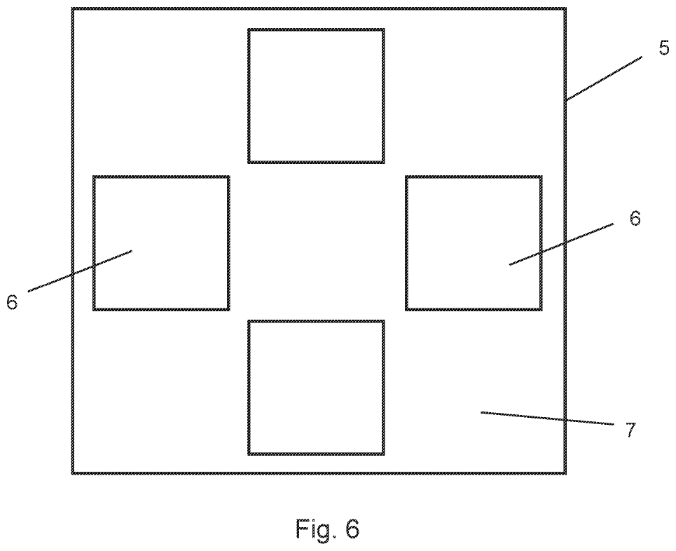

FIGS. 5 and 6 show corresponding plan views of the accommodation element 4 (FIG. 5) and the moving element 5 (FIG. 6) of a device according to FIG. 4. It can be gathered from FIGS. 5 and 6 that the corresponding projections 6 may be designed in a simple basic form such as, for example, in the shape of the illustrated rectangles or squares, and do not need to be modelled on the individual puzzle pieces 3 as in the accommodation element 4 or the moving element 5 of the device according to FIG. 2. This type of design, however, is also conceivable for a device for respectively separating individual puzzle pieces 3 according to the embodiment of FIG. 2. Similar to the device shown in FIGS. 4 to 6 for a segment-wise separation of the puzzle pieces, the projections 6 of the accommodation element 4 and the moving element 5 only need to have smaller dimensions than the complementary cavities as illustrated by the dashed lines in FIG. 5 to protect the peripheral portions of the puzzle pieces 3 to be detached so that they are not sheared by the projections 6 and cavities 7.

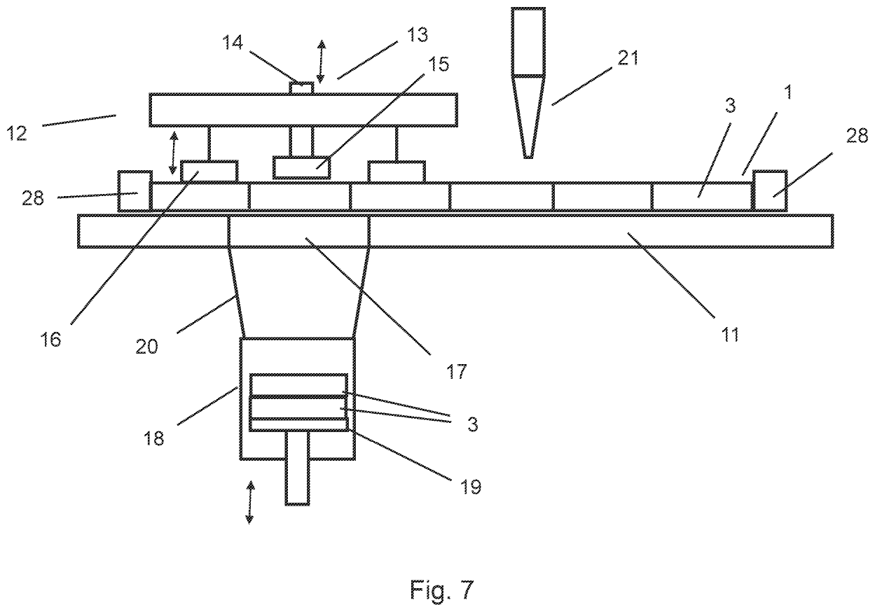

FIG. 7 shows a lateral cross-sectional view of another embodiment of a device according to the invention for separating puzzle pieces 3. In the device according to FIG. 7, the puzzle 1 to be separated including a plurality of puzzle pieces 3 is supported on a perforated plate 11, the perforated plate 11 having at least one, preferably a plurality of holes 17.

Furthermore, a moving element support 12 in which at least one, preferably a plurality of moving elements in the form of dies 13 are arranged is provided in the device according to FIG. 7. The dies 13 include a shaft 14 and a die foot 15 and are movable transverse, particularly perpendicular, to the puzzle plane or to the image plane of the puzzle 1 as indicated by the double-headed arrow. For example, a linear guide for the shaft 14 of the die 13 may be provided in the moving element support 12. The moving element support 12 further includes a fixing ring 16 which is also movable transverse or perpendicular to the puzzle plane or the image plane of the puzzle 1 as indicated by the double-headed arrow.

When a puzzle 1 to be separated is placed on the perforated plate 11 the die 13 can be moved in the direction toward the perforated plate 11 and thereby push the puzzle piece 3 out of the puzzle 1 with the die foot 15 so that the puzzle piece 3 falls down through the hole 17. Of course also the reverse arrangement and moving direction are conceivable so that a die pushes the puzzle piece 3 out in the upward direction.

Under the hole 17, a hopper 20 as well as a receiving container 18 are arranged into which the detached puzzle piece 3 falls. If the hopper 20 and the receiving container 18 are dimensioned so that they only have a diameter or a maximum dimension in a direction parallel to the puzzle plane which is slightly larger than the puzzle pieces 3 to be detached the puzzle pieces 3 will not tilt or skew when falling down, and the puzzle pieces 3 can be accumulated in a stack in the receiving container 18. This can be further supported by the receiving space of the receiving container 18 or the height of fall of the puzzle pieces 3 being adjustable by a piston 19 movable in the receiving container 18 so that the height of fall is as small as possible so that there is no possibility for the puzzle piece 3 to tilt or skew.

For preventing the adjacent puzzle pieces 3 from tilting or shifting when a puzzle piece 3 is pushed out by the die foot 15 of a die 13 the moving element support 12 includes the fixing ring 16 by means of which the adjacent to puzzle pieces 3 are fixed while the puzzle pieces 3 are detached.

The separation of the puzzle pieces 3 of the puzzle 1 to be separated can, in this device according to FIG. 7, now be carried out so that the puzzle 1 to be separated is shifted relative to the die 13 or the dies 13 by means of puzzle moving means so that various puzzle pieces 3 can be successively detached from the puzzle 1. In the embodiment shown, the puzzle moving means include a suction device 21 including one or more suction nozzles for fixing and/or lifting the puzzle 1 to be separated as well as a clamping slide 28 for laterally clamping and pushing the puzzle 1, the suction device 21 and the clamping slide 28 being slidable in directions parallel to the puzzle plane or the image plane of the puzzle 1 so that all puzzle pieces 3 of the puzzle 1 to be separated can be moved under the die or dies 13.

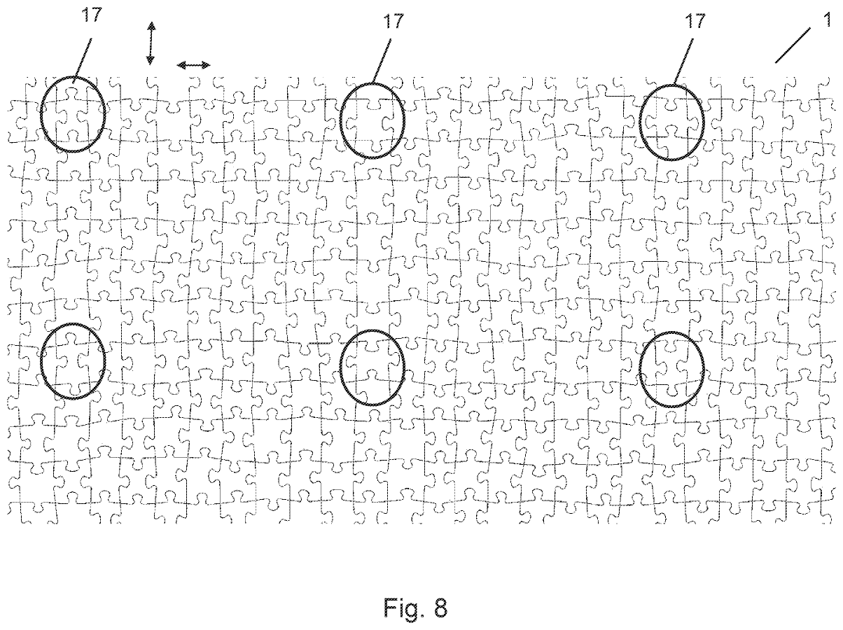

For example, in case of a puzzle including 1000 puzzle pieces 3, a perforated plate 11 having 40 holes 17 as well as a moving element support 12 including 40 dies 13 may be provided so that 40 puzzle pieces 3 can be simultaneously detached and transferred into associated receiving containers 18 in one process of movement for detaching puzzle' pieces 3 from the puzzle 1 to be separated. After the separation of the first 40 puzzle pieces 3, the puzzle 1 is shifted relative to the 40 dies 13 and the 40 holes 17, for example along a row or a column of the puzzle 1, so that the respectively adjacent puzzle pieces 3 can be detached. By 25 subsequent separation movements of the dies 13 and a corresponding grid-like shift of the puzzle 1 relative to the dies 13 and the holes 17, therefore, all puzzle pieces 3 of the puzzle 1 can be separated. It is self-evident that the description of 40 dies and 40 holes of the perforated plate 11 is only an example, and for a person skilled in the art it is a matter of course that the basic principle can be adapted to various numbers of dies 13, holes 17, and puzzle pieces 3 of a puzzle 1. In FIG. 8, a plan view of a puzzle 1 including the indication of holes 17 of a perforated plate 11 disposed below it is shown to illustrate the principle, the shown double-headed arrows indicating the movement of the puzzle 1 relative to the holes 17.

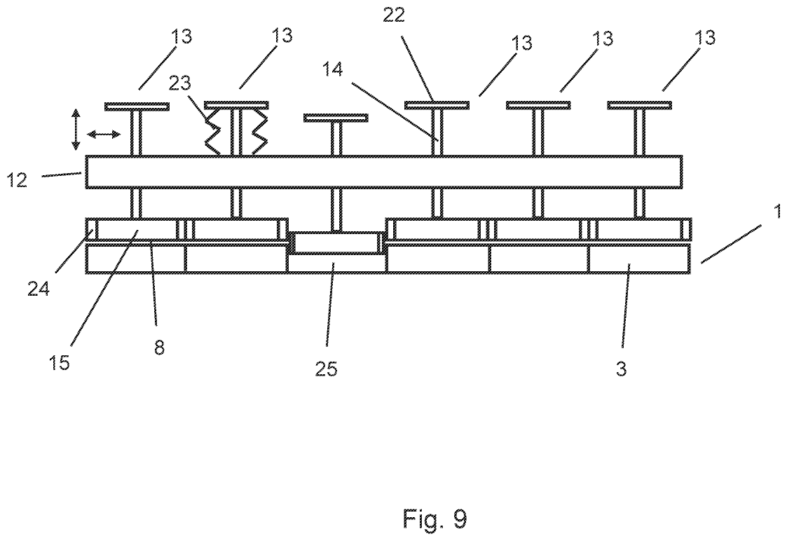

FIG. 9 shows part of another embodiment of a device according to the invention in which the die feet 15 including the contact surfaces 8 almost completely cover the entire surface of the puzzle 1 to be separated so that the die feet 15 are arranged closely adjacent to each other and may also contact each other. Accordingly, an individually operable die 13 is provided for each puzzle piece 3 to be separated so that each individual puzzle piece can be detached from the puzzle 1 as desired in the desired manner without the necessity to shift the puzzle 1 relative to the dies 13.

In the embodiment shown in FIG. 9, the movable dies 13 are biased in a position in the moving element support 12 in which the puzzle pieces 3 cannot be detached from the puzzle 1 by spring elements 23 as shown by way of example on one die 13.

Furthermore, the dies 13 include a pushing plate 22 via which the die 13 can be operated on the end of the shaft 14 opposite to the die foot 15, respectively.

In order to allow for an adaptation of the die to variations in the puzzle 1 to be separated the dies 13 may be adjustable in directions parallel to the puzzle plane or the image plane of the puzzle 1 as indicated by the double-headed arrows in FIG. 9.

In order to minimise mutual wear in case of a full-surface provision of the contact surfaces 8 of the die feet 15 and to prevent the dies 13 from jamming the die feet 15 may, according to the embodiment of FIG. 9, include an elastic material at their lateral peripheral edge.

It can further be gathered from FIG. 9 that the moving element support 12 and the dies 13 movably arranged therein may be configured so that a die 13 which has been operated and has detached a corresponding puzzle piece 3 initially does not return to its original position but remains in its at least partly extended position for detaching the puzzle piece 3 to thereby remain in the gap 25 of the puzzle 1 and thereby ensure a lateral fixation of the puzzle 1.

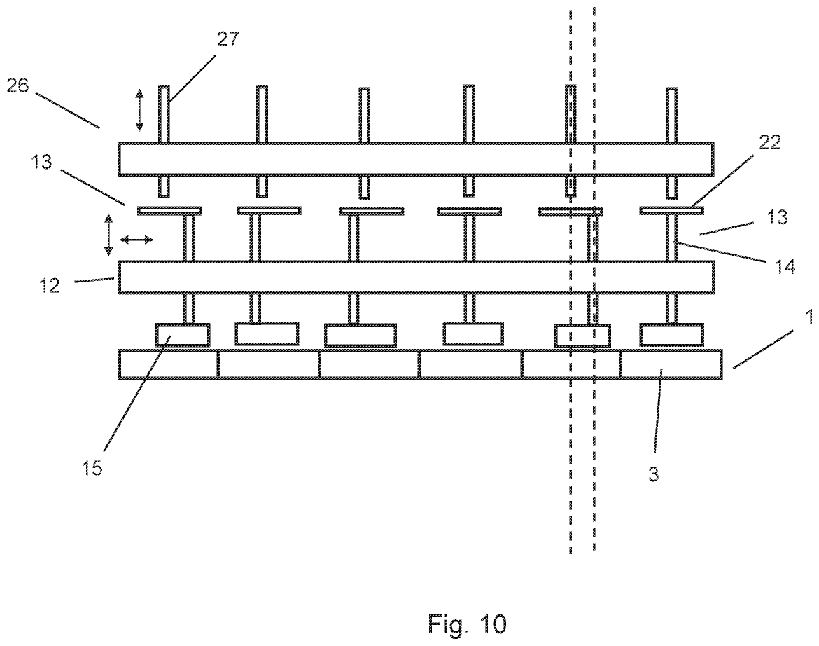

FIG. 10 shows yet another embodiment of a device according to the invention for separating a puzzle 1. The device shown in FIG. 10 is similar to the device of FIG. 9, however, in addition, with operating means 26 for operating the dies 13 being provided. The operating means 26 include a plurality of operating elements 27 corresponding to the number of dies 13, the provision of a smaller number of operating elements 27, however, being possible if these can simultaneously move a plurality of dies 13. In case of the use of a perforated plate with 40 holes, for example, one operating element 27 may be provided for 40 dies 13 so that the dies 13 under which the holes are disposed are moved simultaneously to detach the puzzle pieces.

Similar to the dies 13, the operating elements 27 are movable in a direction transverse to the puzzle plane or the image plane of the puzzle 1 so that the operating elements 27 can push the pushing plates 22 of the dies 13 and these are moved correspondingly. The operating elements 27 are arranged at fixedly predetermined positions in the operating means 26 according to a fixed grid structure. In contrast, the dies 13 of the moving element support 12 including their die feet 15 and the positioning of the shafts 14 in the moving element support 12 are adapted to the design of the puzzle pieces 3 of the puzzle 1 to be separated. Accordingly, the device according to FIG. 10 is configured so that different moving element supports 12 adapted to various puzzles 1 to be separated can be used while the operating means 26 can be universally employed for all different moving element supports 12. In FIG. 10, the dashed lines exemplify how the shaft 14 of a die 13 can be arranged offset from the longitudinal axis of an operating element 27 to obtain an optimum position for the die foot 15 to move the puzzle piece 3 out of the puzzle 1.

Although the present invention was described in detail based on the embodiments, it is obvious to a person skilled in the art that the invention is not limited to these embodiments, but that rather modifications are possible in a way in which individual features are omitted or different combinations of features can be realised without departing from the scope of the appended claims. In particular, the present disclosure includes all combinations of the individual features shown in the various embodiments so that individual features described only in connection with one embodiment or not explicitly illustrated combinations of individual features can also be deployed in other embodiments.

### LIST OF REFERENCE NUMERALS

1 Puzzle
2 Image
3 Puzzle piece
4 Accommodation element
5 Moving element
6 Projection
7 Cavity
8 Contact surface
9 Support surface
10 Suction nozzles
11 Perforated plate
12 Moving element support
13 Die
14 Shaft
15 Die foot
16 Fixation ring
17 Hole
18 Receiving container
19 Piston
20 Hopper
21 Suction device
22 Pushing plate
23 Spring
24 Elastic edge
25 Gap
26 Operating means
27 Operating element
28 Clamping slide
A, B, C . . . Rows and columns

1. A method for producing a puzzle comprising a plurality of puzzle pieces which, in an assembled state, form the puzzle, the method comprising:
(a) laminating or printing an image onto a carrier plate so that the image defines an image plane on the carrier plate and punching the puzzle pieces out of the printed or laminated carrier plate; or
(b) punching the carrier plate and printing an image is printed on the punched carrier plate so that the image defines an image plane on the carrier plate;
wherein the puzzle pieces are detached and separated from the punched carrier plate in a predetermined way by a controlled movement of at least one puzzle piece transverse to the image plane.

2. The method according to claim 1, wherein the controlled movement is performed perpendicular to the image plane.

3. The method according to claim 1, wherein one or more puzzle pieces are simultaneously and/or successively detached from the punched carrier plate, particularly in that up to half of the puzzle pieces of the puzzle are simultaneously detached from the punched carrier plate or in that all puzzle pieces are separated simultaneously.

4. The method according to claim 1, wherein a plurality of sub-segments is defined for the puzzle, wherein each sub-segment comprises specific puzzle pieces and respectively at least one puzzle piece is simultaneously detached from the punched carrier plate for all sub-segments or all puzzle pieces of one or more sub-segments are simultaneously detached from the punched carrier plate, wherein, particularly in case of a detached sub-segment, a further separation of the puzzle pieces of the sub-segment is carried.

5. The method according to claim 4, wherein the puzzle pieces of a sub-segment are defined by at least one characteristic of the puzzle pieces selected from a number of characteristics comprising the association with one or more rows of the puzzle, the association with part of one or more rows of the puzzle, the association with one or more columns of the puzzle, the association with part of one or more columns of the puzzle, the association with an arbitrary local area of the puzzle, one or more primary colours or colour components of the puzzle pieces, the edge pieces of the puzzle, the number of recesses or projections of the puzzle pieces, and combinations thereof.

6. The method according to claim 1, wherein at least one puzzle piece adjacent to the puzzle piece to be detached or all puzzle pieces adjacent to the puzzle piece to be detached or all puzzle pieces adjacent to the puzzle piece to be detached which have a common section line are fixed during the movement of the puzzle piece to be detached.

7. The method according to claim 1, wherein the controlled movement for detaching the at least one puzzle piece is a linear translational movement, particularly a pushing or pulling movement.

8. The method according to claim 1, wherein the detached puzzle pieces are disposed in a common plane which is, in particular, parallelly offset relative to the image plane of the unmoved puzzle pieces after the detachment from the punched carrier plate.

9. The method according to claim 1, wherein, following the controlled movement for detaching the at least one puzzle piece, the at least one puzzle piece is placed in a storage container.

10. The method according to claim 4, wherein the puzzle pieces of a sub-segment are placed and/or stacked in a common storage container.

11. A device for separating puzzle pieces of a puzzle including a plurality of puzzle pieces, wherein the device comprises an accommodation element for the puzzle of puzzle pieces connected to each other and at least one moving element, wherein the at least one moving element is movable relative to the accommodation element so that at least one contact element comes into contact with at least one puzzle piece and the puzzle piece is moved transverse to the accommodation element by the contact element so that the at least one puzzle piece is detached from the puzzle.

12. The device according to claim 11, wherein the at least one moving element is a plate having a plurality, particularly up to half the number of the puzzle pieces to be separated, of projections and cavities on one side, the projections being the contact elements, and in that the accommodation element is a plate having projections and cavities complementary to the moving element, the projections being a support for the puzzle to be separated so that, when the puzzle to be separated is disposed on the accommodation element and the moving element is moved in the direction toward the accommodation element, one or more puzzle pieces are pushed into the complementary cavity of the accommodation element by each projection of the moving element.

13. The device according to claim 12, wherein each cavity or each projection corresponds to at least one puzzle piece and/or one sub-segment of a plurality of puzzle pieces of the puzzle to be separated.

14. The device according to claim 11, wherein the moving element is a movable pushing and/or pulling element, particularly a die and/or a suction element.

15. The device according to claim 11, wherein the contact element is a pushing surface of a pushing element, particularly the die surface of a die, or the coupling surface of a pulling element, particularly the suction nozzle of a suction element.

16. The device according to claim 11, wherein the device comprises a plurality of moving and contact elements which are simultaneously movable so that a plurality of puzzle pieces can be simultaneously detached from the puzzle the to be separated, wherein, in particular, the moving and contact elements are disposed in a moving element support so that one or more moving and contact elements which are simultaneously movable are disposed in one portion of the moving element support, respectively, each portion corresponding to a sub-segment of the puzzle to be separated.

17. The device according to claim 11, wherein the device includes a moving and contact element for each puzzle piece or each sub-segment of the puzzle to be separated, respectively.

18. The device according to claim 11, wherein the contact elements are disposed in a moving element support so that the contact elements almost completely cover the surface of the puzzle to be separated, the contact elements, at least in part, laterally abutting against each other and/or being elastically deformable at their peripheral portion.

19. The device according to claim 11, wherein the moving and/or contact elements are disposed in a moving element support so that the moving and/or contact elements are slidable transverse to the direction of the movement during the detachment of a puzzle piece from the puzzle to be separated in at least one, preferably in two directions extending transverse to each other within the moving element support.

20. The device according to claim 11, wherein the contact element has a contact surface which is adapted to the size of the allocated puzzle piece or sub-segment or the allocated puzzle pieces or sub-segments of the puzzle to be separated.

21. The device according to claim 11, wherein the device includes fixation means serving to fix the puzzle pieces disposed adjacent to a puzzle piece to be detached which are not to be detached, the fixation means, in particular, comprising a clamping ring or frame by means of which the puzzle piece or the puzzle pieces to be fixed can be clamped against the accommodation element.

22. The device according to claim 11, wherein at least one moving and/or contact element is formed so that the at least one moving and/or contact element has a fixing position in which the at least one moving and/or contact element fixes one or more puzzle pieces laterally and/or in the direction of the movement during the detachment.

23. The device according to claim 11, wherein the accommodation element includes a support plate for supporting the puzzle to be separated, the support plate having, in particular, at least one, preferably a plurality of holes through which the at least one moving and/or contact element or a detached puzzle piece (3) can be moved, a moving and/or contact element being, in particular, allocated to each hole.

24. The device according to claim 11, wherein the at least one moving and/or contact element, particularly together with a moving element support in which the at least one moving and/or contact element it is accommodated, and/or the accommodation element is/are movable transverse to the direction of the movement during the detachment of a puzzle piece from the puzzle to be separated in at least one, preferably in two directions extending transverse to each other relative to the puzzle to be separated.

25. The device according to claim 11, wherein the device comprises puzzle moving means by means of which the puzzle to be separated or parts of a remaining puzzle is/are movable relative to a moving element support and/or to the accommodation element, particularly slidable on the accommodation element.

26. The device according to claim 11, wherein the device includes puzzle part take-up means for taking up an individual or a plurality of detached puzzle pieces which comprises a gripping or suction device for at least one puzzle piece and/or a receiving container, particularly a cylindrical receiving container having a diameter adjusted to the puzzle pieces or a receiving container having grid or perforated walls, a receiving space in the receiving container preferably being adjustable by a movable piston.

27. The device according to claim 11, wherein the device includes operating means for operating the moving element or the moving elements which preferably include one or more operating elements allocated to the moving elements which are, in particular, disposed at fixedly predetermined positions in a direction transverse to the direction of the movement during the detachment of a puzzle piece.
